(19) United States
(12) Patent Application Publication
(10) Pub. No.: US 2003/0159069 A1
(43) Pub. Date: Aug. 21, 2003

(54) Network-based attack tracing system and method using distributed agent and manager system

(76) Inventors: Byeong Cheol Choi, Taejon (KR); Yang Seo Choi, Taejon (KR); Dong Ho Kang, Taejon (KR); Dong Il Seo, Taejon (KR); Sung Won Sohn, Taejon (KR); Chee Hang Park, Taejon (KR)

Correspondence Address: JACOBSON, PRICE, HOLMAN & STERN, PROFESSIONAL LIMITED LIABILITY COMPANY, 400 Seventh Street, N.W., Washington, DC, 20004, US

(21) Appl. No.: 10/273,139

(22) Filed: Oct. 18, 2002

(30) Foreign Application Priority Data
Feb. 19, 2002 (KR) 2002-8654

(51) Int. Cl. G06F 11/30

(52) U.S. Cl. 713/201

(57) ABSTRACT

Disclosed is a network-based attack tracing system and method using a distributed attack detection agent and manager system that can detect and trace an attack path of a hacker in real time on the whole network using distributed network-based attack detection agent, request manager, and reply manager. The agent detects an attack using a network-based intrusion detection system (NIDS), analyzes an alarm log that is judged to be the attack, changes the analyzed alarm log into attack information, and transmits the attack information to the request manager. The request manager performs a search of an attack IP based on the attack information received from the agent, stores a result of search in a tree structure, and if a final search is completed, extracts a hacking path using a binary search tree (BST) algorithm. The reply manager searches an alarm log DB located in the agent of its own network in response to the attack information search request from the request manager, and transmits a result of search to the request manager. The system and method can use the detection function of the existing NIDS at maximum, control unnecessary tracing requests during the process of judging many alarm logs as the attack logs, and broaden its application range in case of the authenticated network.

### BACKGROUND OF THE INVENTION

1. Field of the Invention

The present invention relates to an attack tracing system and method that detects an attacking hacker on a computer network and traces its attack path, and more particularly, to a network-based attack tracing system and method using a distributed attack detection agent and manager system.

2. Background of the Related Art

When an attacker intrudes into a computer network, the existing network-based intrusion detection system (hereinafter referred to as NIDS), which is distributed over the whole network, detects an attack, and traces an attack path of the hacker using the NIDS.

FIG. 1 is a view illustrating a whole network structure showing a mutual relationship between an attack detection agent and a manager for tracing an attacker.

Referring to FIG. 1, if a hacker's attack to a network segment to which an agent 102 of a first network 101 having an NIDS mounted thereon belongs is found, a request manager 103 of the first network 101 is requested to trace the attack.

The request manager 103, if the attacker's IP is the one that belongs to its own network area, requests an attack information search to an internal reply manager 104, and then receives a reply from the reply manager. If the attacker's IP belongs to a second network, the request manager will request the attack information search to a reply manager 105 of the second network.

By performing such an attack information search request and reply process in circulation, the result of tracing is finally stored in a tracing result DB of the request manager 103 belonging to the agent 102 that first sent the attack path request message, so that the hacker's path can be traced in real time.

The conventional network-based intrusion detection system (NIDS), however, has the problems in that it just performs the intrusion detection in the network where the NIDS is installed, and thus if the hacker's attack is performed via several networks, the first attacker cannot be detected.

### SUMMARY OF THE INVENTION

Accordingly, the present invention is directed to a network-based attack tracing system and method using a distributed attack detection agent and manager system that substantially obviate one or more problems due to limitations and disadvantages of the related art.

It is an object of the present invention to provide a network-based attack tracing system and method using a distributed attack detection agent and manager system that can detect and trace an attack path of a hacker in real time on the whole network using distributed network-based attack detection agent and manager (i.e., request manager and reply manager).

According to the network-based attack tracing system and method according to the present invention, the agent having a network-based attack detection system (NIDS) mounted thereon judges a hacker's attack, records an alarm log, and then requests to the request manager an attack path search request through a process of applying an attack rule and processing attack statistics based on the alarm log. Accordingly, the request manager searches an alarm log DB, and replies the attacker's traces to reply managers of its own network and other authenticated networks. The above-described process is performed in circulation, so that the attacker's path can be traced.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a network-based attack tracing system using a distributed attack detection agent and manager system, comprising an agent for detecting an external attack, storing a result of detection in an alarm log DB, and performing a log analysis through a real-time monitoring of the alarm log DB, the agent changing analyzed log information to attack information, storing the attack information in an attack log DB, and then transmitting the attack information through a UDP communication; a request manager for performing a search request of IP information included in the attack information received from the agent; and a reply manager for searching an attack IP from the alarm log DB of an agent of a sub network to which the corresponding attack IP of its own network in accordance with the IP search request from the request manager, and transmitting a result of search to the request manager, wherein if there is another passing IP, the request manager continuously requests the attack information search to a reply manager of another network, and if the above process is completed, the request manager stores a result of tracing a hacking path in a tracing result DB.

In another aspect of the present invention, there is provided a network-based attack tracing method using a distributed attack detection agent and manager system, comprising the steps of an agent detecting an attack using a network-based intrusion detection system (NIDS), analyzing an alarm log that is judged to be the attack, changing the analyzed alarm log into attack information, and transmitting the attack information to the request manager; a request manager performing a search of an attack IP based on the attack information received from the agent, storing a result of search in a tree structure, and if a final search is completed, extracting a hacking path using a binary search tree (BST) algorithm; and a reply manager searching an alarm log DB located in the agent of its own network in response to the attack information search request from the request manager, and transmitting a result of search to the request manager.

Preferably, the step of analyzing the alarm log, changing the alarm log to the attack information, and transmitting the attack information to the request manager includes the steps of detecting the attack by the NIDS, storing the detected attack in the alarm log DB, and monitoring the alarm log DB in real time; when the alarm log DB is updated by new information, applying an attack log rule for judging the information as the attack information; finally judging the updated information as the attack by applying a threshold value according to an attack method to the detection frequency of IPs and signatures for being judged as the attack information after the attack log rule is applied; and reporting to the request manager and storing the finally judged attack information.

Preferably, the step of performing the search of the attack IP based on the attack information received from the agent, storing the result of search in the tree structure, and extracting the hacking path using the BST algorithm includes the steps of receiving the attack information from the agent, and selecting the manager to which the attack IP belongs; requesting the search of the attack IP to the reply manager of the selected network, and receiving a result of search from the reply manager; storing the result of search from the reply manager in a memory of the tree structure, and after the search is finally completed, using the BST algorithm for extracting the tracing path; and storing the extracted hacking path in a tracing result DB.

Preferably, the step of searching the alarm log DB in the agent of its own network in accordance with the attack information search request from the request manager, and transmitting a result of search to the request manager includes the steps of starting a search process by generating a child process in response to the attack IP search request from the request manager; authenticating the network corresponding to the IP subject to the search request; searching the alarm log DB of the agent managed by itself with respect to an authenticated search request packet, extracting and storing a result of search; and transmitting the extracted search result to the request manager.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a view illustrating a whole network structure showing a mutual relationship between an attack detection agent and a manager for tracing an attacker.

FIG. 2 is a block diagram of a network-based attack tracing system according to the present invention.

FIG. 3 is a flowchart illustrating the operation of an agent system that detects the attack and reports attack information to a manager in a network-based attack tracing system according to the present invention.

FIG. 4 is a flowchart illustrating the operation of a request manager system that manages receiving and tracing of an attack alarm in a network-based attack tracing system according to the present invention.

FIG. 5 is a flowchart illustrating the operation of a reply manager system that searches traces of an attacker and replies to circular traces of the request manager in response to a request of the request manager in a network-based attack tracing system according to the present invention.

### DETAILED DESCRIPTION OF THE PREFERRED EMBODIMENT

The network-based attack tracing system and method using a distributed attack detection agent and manager system according to the preferred embodiment of the present invention will now be explained in detail with reference to the accompanying drawings.

Referring to FIG. 1, if a hacker's attack is detected in the network-based attack tracing system according to the present invention, an alarm is generated, and then an agent 102 that changes an alarm log to attack information starts tracing.

The agents are installed in the unit of a network segment of a C-class. If the C-class network is composed of two sub networks, two agents should be installed.

The agent 102 transmits the attack information to a request manager 103 of the network (i.e., B-class network) to which the agent 102 belongs, so that the request manager 103 can start the whole management of the tracing.

The request manager 103 judges which network an attack IP sent from the agent 102 belongs to, and requests a search for the attack IP to a reply manager 104, 105 or 107 of the corresponding network. Here, the case that an attacker in an N-th network attacks a first network via a second network will be explained as an example.

First, the agent 102 of the first network 101 transmits the attack information to the request manager 103, and the request manager 103 requests a search for the attack IP to the reply manager 105 of the second network with the IP of the previous attacker.

Then, the reply manager 105 searches an alarm log DB in the agent 106, and transmits a result of search to the initial request manager 103.

The request manager 103 that received the result of search ascertains another passing IP by analyzing the search result, performs a search for the attack IP to the reply manager 107 of the N-th network in the same manner as above, and transmits a result of search to the initial request manager 103.

If no more search for the attack IP is finally required, the request manager 103 extracts a hacking path based on the result of search.

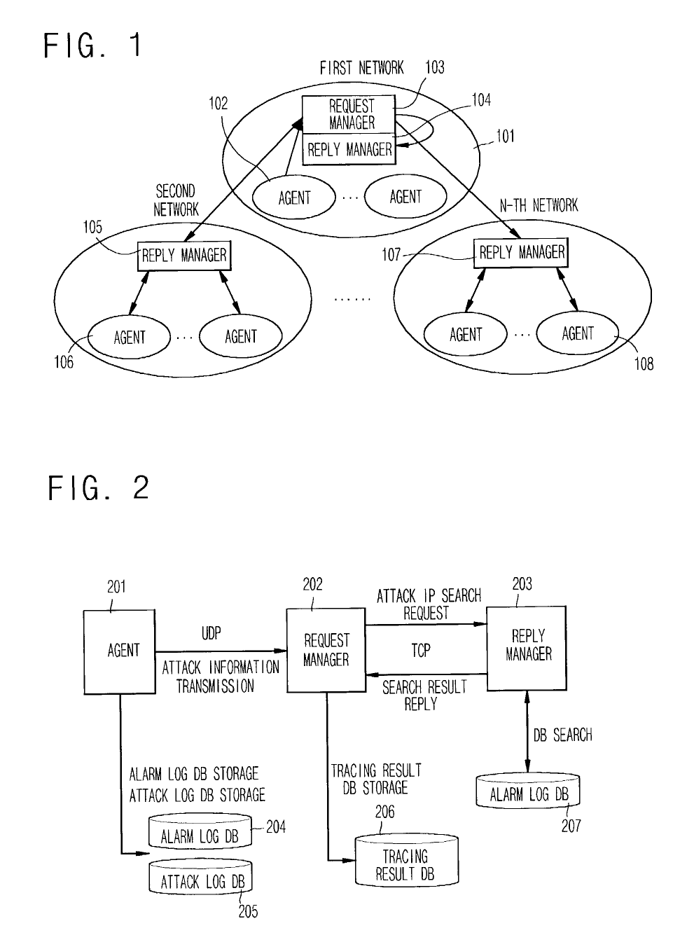

FIG. 2 is a block diagram of a network-based attack tracing system according to the present invention. FIG. 1 shows in detail one network (in the unit of a B-class) in FIG. 1.

As shown in FIG. 2, an agent 201 detects an attack, and stores a result of detection in an alarm log DB 204. Then, the agent 201 performs a log analysis through a real-time monitoring, changes the analyzed alarm log information to attack information, and then stores the attack information in an attack log DB 205. Then, the agent 201 transmits the attack information to the request manager 202 through the UDP communication.

The request manager 202 requests an IP search to the reply manager 203 that belongs to the corresponding network through the TCP communication based on the IP included in the attack information received from the agent 201. The reply manager 203 searches the attack IP from the alarm log DB 207 of the agent of the sub network to which the. corresponding attack IP of its own network belongs, and transmits a result of search to the request manager 202.

The request manager 202, if another passing IP exists, continuously requests the attack information search to the reply manager of another network, and if a series of such processes is completed, the request manager stores the result of tracing the hacking path in the tracing result DB 206.

Hereinafter, the network-based attack tracing method using the distributed attack detection agent and manager system according to the present invention will be explained by stages with reference to the accompanying drawings.

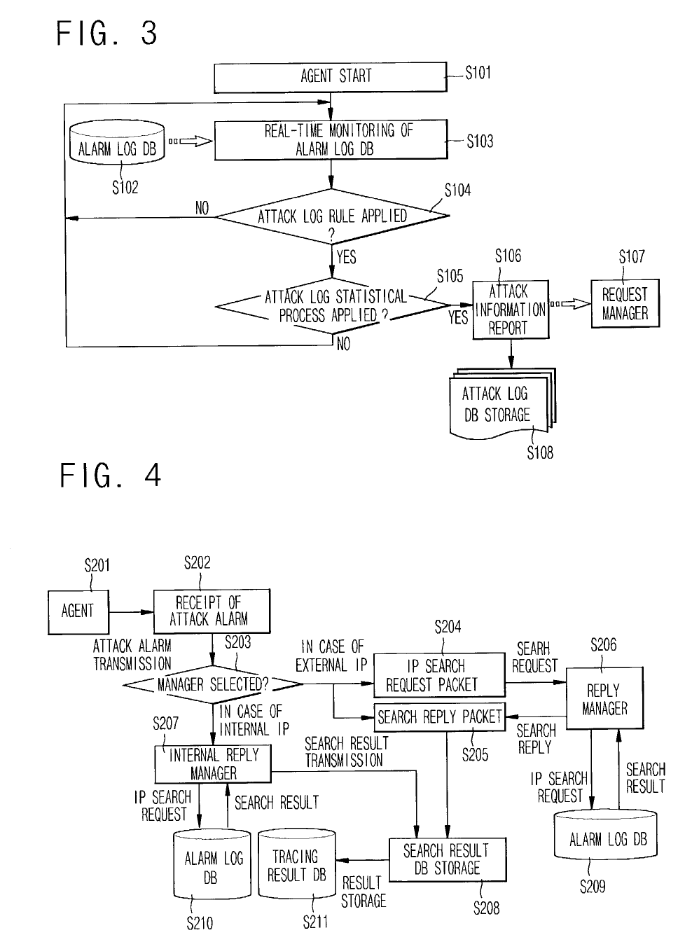

FIG. 3 is a flowchart illustrating the operation of an agent system that detects the attack and reports attack information to a manager in a network-based attack tracing system according to the present invention.

Referring to FIG. 3, if the agent starts (step S101), the detection result obtained by the network-based attack detection system (NIDS) is stored in the alarm log DB (step S102), and the real-time monitoring of this alarm log DB is performed (step S103).

Then, if the alarm log DB is updated, i.e., if a new attack is detected, it is judged whether to apply the attack log rule (step S104), and if the attack log rule is applied as a result of judgment, it is judged whether to apply a statistical process for the attack log (step S105).

In the event that the attack log rule is applied and the attack log statistical process is applied as a result of judgment, the attack information is reported to the request manager (steps S106 and S107), and the attack information is stored in the attack log DB (step S 108).

FIG. 4 is a flowchart illustrating the operation of a request manager system that manages receiving and tracing of an attack alarm in a network-based attack tracing system according to the present invention.

Referring to FIG. 4, the request manager (step S201) receives the attack information from the agent (step S202).

Accordingly, the manager is selected by discriminating whether the corresponding IP is the IP of the internal network or the IP of the external network based on the attack IP (step S203).

If the selected manager corresponds to the IP of the internal network, the request manager requests the internal reply manager to search the alarm log DB (step S207), and the internal reply manager stores the search result of the alarm log DB in the search result DB (step S208).

However, if the attack IP is the IP of the external network, the request manager requests the reply manager (step S206) of the external network to search the attack IP from the alarm log DB (step S209) by transmitting an IP search request packet to the reply manager of the external network (step S204).

Accordingly, the reply manager searches the attack IP from the alarm log DB according to the search request, transmits a result of search, i.e., a search reply packet, and then stores the result of search in the search result DB (step S208).

If all the circular request and reply processes as described above are completed, the attack path and other attack information are finally stored in the tracing result DB (step S211).

Here, the request manager stores the search result of the attack information in a memory having the tree structure, and if the final search is completed, it efficiently and promptly extracts all the possible paths using the binary search tree (BST) algorithm.

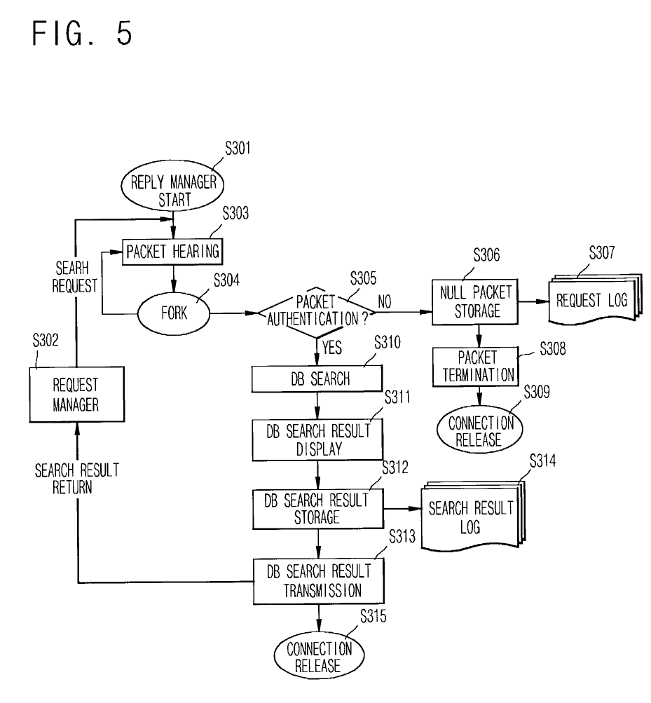

FIG. 5 is a flowchart illustrating the operation of a reply manager system that searches traces of an attacker and replies to circular traces of the request manager in response to a request of the request manager in a network-based attack tracing system according to the present invention.

Referring to FIG. 5, if a search request is inputted from the request manager (step S302), the packet hearing operates (step S303), and a fork that generates a new child process is performed (step S304).

With respect to the received attack request IP, the packet authentication is performed (step S305).

If the attack request IP is the request in the authenticated network as a result of performing the packet authentication, the reply manager searches the alarm log DB of its own agent (step S310), and displays a result of DB search (step S311).

Then, the reply manager stores the result of searching the alarm log DB of the agent in the search result log (step S312), transmits the search result to the request manager (step S313), and then terminates the corresponding child process.

However, if the attack request IP is the IP of the network that is not authenticated in the packet authentication process (step S305) at the step S305, the reply manager judges it as a null packet, stores (step S306) it in a request log (step S307), and then performs the packet termination (step S308) and connection release (step S309).

As described above, the network-based attack tracing system and method using the distributed attack detection agent and manager system according to the present invention has the advantages in that it can use the detection function of the existing network-based intrusion detection system (NIDS) at maximum, control unnecessary tracing requests during the process of judging many alarm logs as the attack logs, and broaden its application range in case of the authenticated network. Also, the network-based attack tracing system and method according to the present invention can perform the effective result storage and the tracing path extraction using the tree structure storage and the binary search tree (BST) algorithm, and trace the hacker's path in real time.

While the present invention has been described illustrated herein with reference to the preferred embodiment thereof, it will be understood by those skilled in the art that various changes and modifications may be made to the invention without departing from the spirit and scope of the invention, which is defined in the appended claims.

What is claimed is:

1. A network-based attack tracing system using a distributed attack detection agent and manager system, the system comprising:
an agent for detecting an external attack, storing a result of detection in an alarm log DB, and performing a log analysis through a real-time monitoring of the alarm log DB, the agent changing analyzed log information to attack information, storing the attack information in an attack log DB, and then transmitting the attack information through a UDP communication;
a request manager for performing a search request of IP information included in the attack information received from the agent; and
a reply manager for searching an attack IP from the alarm log DB of an agent of a sub network to which the corresponding attack IP of its own network in accordance with the IP search request from the request manager, and transmitting a result of search to the request manager;
wherein if there is another passing IP, the request manager continuously requests the attack information search to a reply manager of another network, and if the above process is completed, the request manager stores a result of tracing a hacking path in a tracing result DB.

2. A network-based attack tracing method using a distributed attack detection agent, request manager, and reply manager system, the method comprising the steps of:
an agent detecting an attack using a network-based intrusion detection system (NIDS), analyzing an alarm log that is judged to be the attack, changing the analyzed alarm log into attack information, and transmitting the attack information to the request manager;
a request manager performing a search of an attack IP based on the attack information received from the agent, storing a result of search in a tree structure, and if a final search is completed, extracting a hacking path using a binary search tree (BST) algorithm; and
a reply manager searching an alarm log DB located in the agent of its own network in response to the attack information search request from the request manager, and transmitting a result of search to the request manager.

3. The network-based attack tracing method of claim 2, wherein the step of analyzing the alarm log, changing the alarm log to the attack information, and transmitting the attack information to the request manager comprises the steps of:
detecting the attack by the NIDS, storing the detected attack in the alarm log DB, and monitoring the alarm log DB in real time;
when the alarm log DB is updated by new information, applying an attack log rule for judging the information as the attack information;
finally judging the updated information as the attack by applying a threshold value according to an attack method to the detection frequency of IPs and signatures for being judged as the attack information after the attack log rule is applied; and
reporting to the request manager and storing the finally judged attack information.

4. The network-based attack tracing method of claim 2, wherein the step of performing the search of the attack IP based on the attack information received from the agent, storing the result of search in the tree structure, and extracting the hacking path using the BST algorithm comprises the steps of:
receiving the attack information from the agent, and selecting the manager to which the attack IP belongs;
requesting the search of the attack IP to the reply manager of the selected network, and receiving a result of search from the reply manager;
storing the result of search from the reply manager in a memory of the tree structure, and after the search is finally completed, using the BST algorithm for extracting the tracing path; and
storing the extracted hacking path in a tracing result DB.

5. The network-based attack tracing method of claim 2, wherein the step of searching the alarm log DB in the agent of its own network in accordance with the attack information search request from the request manager, and transmitting a result of search to the request manager comprises the steps of:
starting a search process by generating a child process in response to the attack IP search request from the request manager;
authenticating the network corresponding to the IP subject to the search request;
searching the alarm log DB of the agent managed by itself with respect to an authenticated search request packet, extracting and storing a result of search; and
transmitting the extracted search result to the request manager.
